(19) United States
(12) Patent Application Publication
(10) Pub. No.: US 2023/0191344 A1
(43) Pub. Date: Jun. 22, 2023

(54) DISTRIBUTION TUBE FOR STATIC MIXER

(71) Applicant: Deere & Company, Moline, IL (US)

(72) Inventors: Tyler J. WARNKE, Clarion, IA (US); Samuel W. DRENTH, Boone, IA (US); Curtis J. SPORRER, Glidden, IA (US)

(73) Assignee: Deere & Company, Moline, IL (US)

(21) Appl. No.: 17/973,881

(22) Filed: Oct. 26, 2022

Related U.S. Application Data
(60) Provisional application No. 63/291,706, filed on Dec. 20, 2021.

(51) Int. Cl. B01F 25/314; B01F 35/71; B01F 25/431; B01F 35/13; B01F 23/451; B01F 23/40

(52) U.S. Cl. CPC B01F 25/3141; B01F 35/7176; B01F 25/43161; B01F 25/43162; B01F 35/13; B01F 23/451; B01F 23/49; B01F 25/3142; B01F 25/3143

(57) ABSTRACT

A distribution tube for a static mixer provides efficient mixing with improved performance over a wide range of flow rates. The distribution tube is positioned near an inlet side of the static mixer. An injected fluid is introduced into the static mixer via the distribution tube, which pre-mixes the injected fluid with a main fluid prior to further mixing by mixing elements of the static mixer.

### BACKGROUND

In various examples, product may be applied to an area via a sprayer. In agriculture, for example, a sprayer mounted to a boom of an agricultural vehicle may be employed to apply various products to crops. The product may include two or more components, which are mixed prior to expulsion by the sprayer. A mixer may be mounted on the agricultural vehicle to combine the two or more components.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a system is provided. The system includes a primary reservoir configured to store a first fluid. The system also includes a secondary reservoir configured to store a second fluid. The system further includes a primary pump configured to supply a first flow of the first fluid from the primary reservoir and a secondary pump configured to supply a second flow of the second fluid from the secondary reservoir. In addition, the system includes a static mixer configured to receive the first flow at a primary inlet, receive the second flow at an injection port, and output a mixed fluid at an outlet. The static mixer includes a distribution tube coupled to the injection port. The distribution tube is configured to pre-mix the first fluid and the second fluid prior to mixing by one or more mixing elements of the static mixer.

In another implementation, a static mixer is provided. The static mixer includes a a mixing chamber having one or more mixing elements. The static mixer further includes an inlet at a first end of mixing chamber and configured to receive a first fluid and an outlet positioned at a second end of mixing chamber, opposed from the first end, and configured to output a mixed fluid. In addition, the static mixer also includes a distribution tube inserted into the mixing chamber and configured to pre-mix the first fluid with a second fluid prior to further mixing by the one or more mixing elements.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

Various non-limiting embodiments are further described in the detailed description given below with reference the accompanying drawings, which are incorporated in and constitute a part of the specification.

FIG. 1 illustrates an exemplary, non-limiting implementation of a mixing system according to various aspects.

FIG. 2 illustrates an exemplary, non-limiting implementation of a static mixer in accordance with various aspects.

FIG. 3 illustrates an exemplary, non-limiting implementation of a static mixer in accordance with various aspects.

### DETAILED DESCRIPTION

As described above, a sprayer system may be employed to apply product having two or more components mixed together. For instance, an agricultural sprayer system may be installed on an agricultural vehicle to apply a product to crops. In some implementations, the two or more components combined to form the sprayed product may be separately stored on the vehicle and mixed just prior to being expelled by the sprayer. In some examples, a static mixer is employed to combine the components. A static mixer does not utilize moving components to mix fluids. Rather, the fluids are mixed as they pass through the mixer. Specifically, the fluids mix as they are disrupted by static mixing elements as the fluids flow.

A static mixer is provisioned with multiple mixing elements to provide a sufficient mix at low flow rates (e.g., low fluid velocities). At high flow rates (e.g., high fluid velocities), fewer mixing elements are required to provide a sufficient mix. Some sprayer systems are expected to operate over a wide range of flow rates. Accordingly, static mixers are typically designed with a number of mixing elements to accommodate a low flow rate case. These mixing elements, however, create a performance loss in high flow rate cases due to additional frictional losses. To counteract these losses, a larger pump is provisioned and/or more power is consumed to achieve a desired performance level. In other implementations, multiple injection sites (e.g. location on the static mixer where a secondary component is introduced) may be utilized on the static mixer.

In accordance with various examples, a distribution tube for a static mixer is provided to enable efficient mixing with improved performance over a wide range of flow rates. The distribution tube may be positioned at an inlet side of the static mixer. A secondary component or an injected product may be introduced into the static mixer via the distribution tube. The distribution tube pre-mixes the injected product with a primary component or product prior to mixing elements of the static mixer. The pre-mixing enables the static mixer to include fewer mixing elements but still create a sufficient mix of a main product and an injected product. The reduction in a number of mixing elements also reduces energy loss due to friction, particularly in high flow rate situations.

According to a further aspect, the distribution tube includes a self-cleaning opening to enable cleaning of the distribution tube even when an injected product is not introduced. The self-cleaning reduce contamination of a main product line due to residual components remaining in distribution tube from prior operations.

In one implementation, a system is described that includes a primary reservoir configured to store a first fluid, a secondary reservoir to store a second fluid, a primary pump configured to a supply a first flow of the first fluid from the primary reservoir, and a secondary pump configured to supply a second flow of the second fluid from the secondary reservoir. The system further includes a static mixer configured to receive the first flow at a primary inlet, to receive the second flow at an injection port, and to output a mixed fluid at an outlet. The static mixer includes a distribution tube coupled to the injection port. The distribution tube is configured to pre-mix the first fluid and the second fluid prior to mixing by one or more mixing elements of the static mixer.

In a further example, the distribution tube extends substantially across an inner diameter of the static mixer. An end of the distribution tube that is opposed from the injection port is open. The open end of the distribution tube facilitates self-cleaning of the distribution tube of residual second fluid.

In another example, the distribution tube includes one or more openings to disperse the second fluid into the static mixer. The one or more openings include a plurality of openings grouped into pairs. Each pair includes respective openings diametrically opposed to each other. A first pair is positioned adjacent to the injection port and a second pair is positioned adjacent to an end longitudinally opposed from the injection port. In yet another example, the one or more mixing elements include a first number of mixing elements, and wherein the number of mixing elements is less than a second number of mixing elements of a static mixer lacking without a distribution tube.

In another implementation, a static mixer is described. The static mixer includes a mixing chamber having one or more mixing elements; an inlet at a first end of mixing chamber and configured to receive a first fluid; an outlet positioned at a second end of mixing chamber, opposed from the first end, and configured to output a mixed fluid; and a distribution tube inserted into the mixing chamber and configured to pre-mix the first fluid with a second fluid prior to further mixing by the one or more mixing elements.

According to various examples, the distribution tube includes an injection port configured to receive the second fluid and the distribution tube extends substantially across an inner dimension of the mixing chamber. In addition, the distribution tube includes a plurality of openings positioned along a length of the distribution tube. The plurality of openings disperse the second fluid into the mixing chamber. The plurality of openings include a first set of openings positioned near a first end of distribution tube within the mixing chamber. The plurality of openings include a second set of openings positioned near a second end of the distribution tube within the mixing chamber. The second set of openings have a smaller dimension than the first set of openings.

In a further example, the second end of the distribution tube is open to the mixing chamber. The second end is longitudinally opposed to the injection port. The second end of the distribution tube facilitate self-cleaning of the distribution tube.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Some of the examples below consider a static mixer, as described herein, in an agricultural setting. It is to be appreciated that the static mixer and distribution tube provided herein are applicable to other, non-agricultural environments. For instance, the static mixer and/or distribution tube provided herein may be utilized in substantially any system or setting having a static mixer

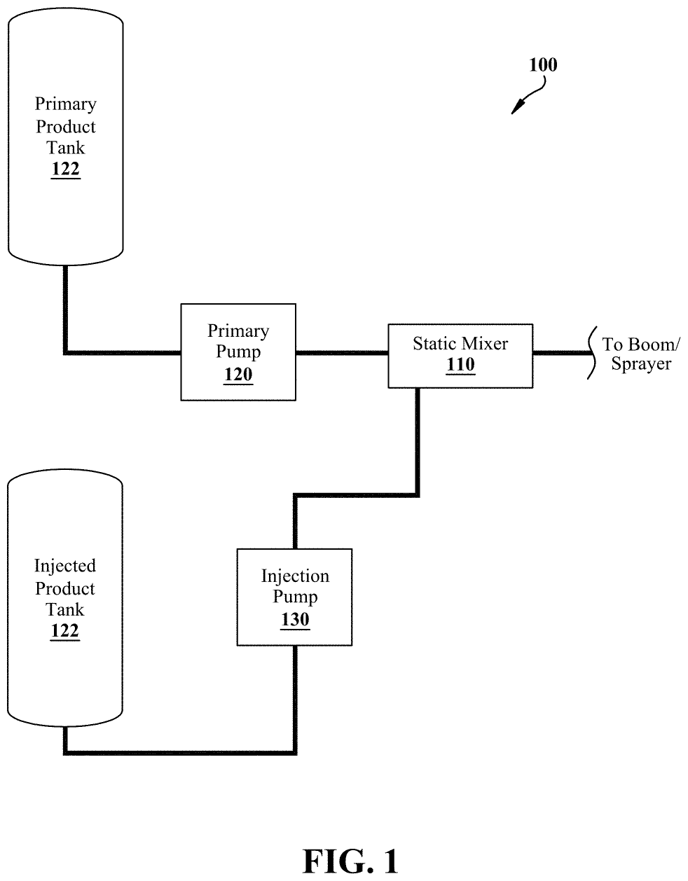

Referring initially to FIG. 1, a mixing system 100 is illustrated. In one example, the system 100 may be included in or utilized by an agricultural vehicle, such as a tractor or a self-propelled sprayer, to provide apply a mixed product to in an agricultural environment (e.g. spraying crops or weeds) via a boom-mounted sprayer. It is to be appreciated, however, that aspects described herein may be utilized in non-agricultural settings such as, but not limited to, substantially any system utilizing static mixers to combine components.

As shown in FIG. 1, the mixing system 100 includes a static mixer 110 that outputs a mixed product to a boom and/or sprayer for application. The static mixer 110 receives a primary product, stored in a primary product tank 122, via a primary pump 120 and receives an injected product, stored in an injected product tank 132, via an injection pump 130. The static mixer 110 combines the primary product and the injected product to produce the mixed product.

In some examples, a pressure and flow rate for the spray may be provided by primary pump 120. The injection pump 130 may output a sufficient flow rate to introduce the injected product into the static mixer 110 to provide a suitable ratio in the mixed product. The injection pump 130 may introduce the injected product into the static mixer 110 via one or more injection ports provided thereon.

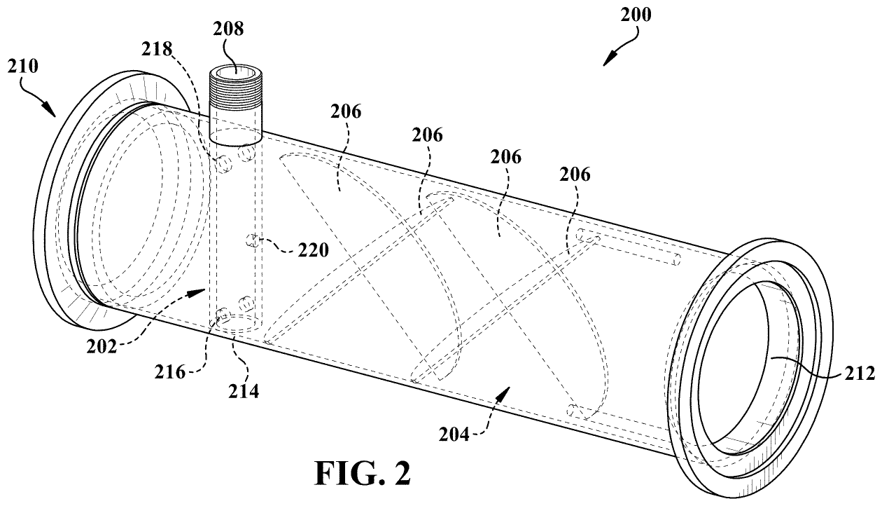

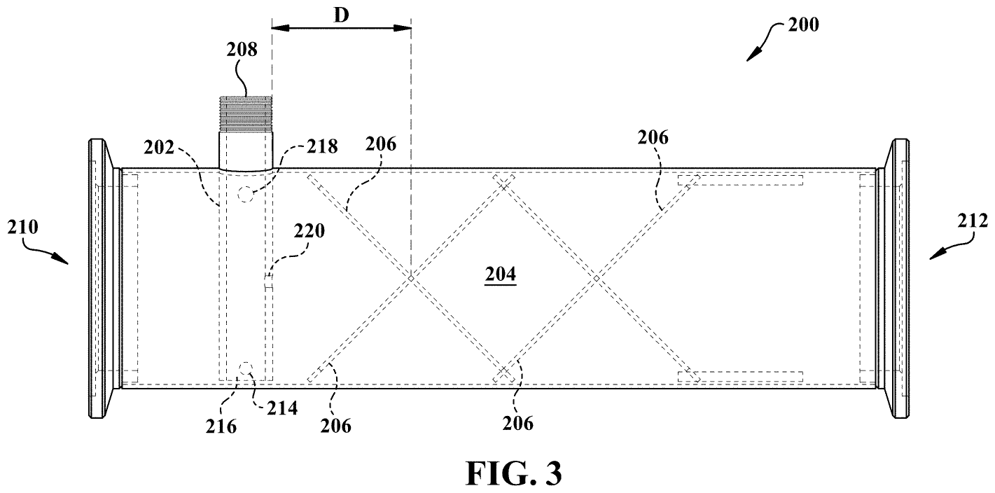

Turning to FIGS. 2 and 3, an exemplary, non-limiting schematic implementation of a static mixer 200 is depicted. Static mixer 200 may implement static mixer 110 of mixing system 100 illustrated in FIG. 1, for example.

As shown in FIGS. 2 and 3, the static mixer 200 includes an inlet 210 at which a main or primary product is received and an outlet 212 where a mixed product is output. The static mixer 200 further includes a distribution tube 202 having an injection port 208 at which an injected product is received. The main product and the injected product are mixed in a mixing chamber 204 by one or more mixing elements 206.

In accordance with an aspect, the distribution tube 202 provides a pre-mix of the injected product and the main product prior to the one or more mixing elements 206. As shown, the distribution tube 202 includes one or more openings positioned along a length of the distribution tube 202. In an example, a pair of openings 218 may located at an upper portion of the distribution tube 202, a pair of openings 216 may be positioned at a lower portion of the distribution tube 202, and an opening 220 may be positioned at a forward location near a midpoint of the distribution tube 202. The positioning of the openings in FIGS. 2 and 3 are merely exemplary and alternative arrangements are possible. For instance, additional openings may be provided for larger implementations of static mixer 200 as such implementation may include a longer distribution tube 202, for example. The openings 216, 218, and/or 220 allow the injected product to disperse into the main product to create the pre-mix. In one implementation, the openings 216 at the lower portion may be smaller in diameter than the openings 218 at the upper portion to provide equal flow.

The introduction of the distribution tube 202 pre-mixes the injected product with the main product. As noted above, in accordance with an aspect, the pre-mixing created by the distribution tube 202 enables the static mixer 200 to provide substantially similar mixing capability as a static mixer having more mixing elements 206. For example, FIGS. 2 and 3 illustrate static mixer 200 having four mixing elements 206. The distribution tube 202 enables static mixer 200 to output a mixed product substantially similar to a static mixer having, for instance, eight mixing elements. In other words, the distribution tube 202 may provide a reduction of 50% in a number mixing elements sufficient to achieved a given performance level. Moreover, as noted above, the reduction in mixing elements increases flow performance due to the corresponding reduction in frictional losses.

As further shown in FIG. 2, the distribution tube 202 may include an open bottom portion 214 for self-cleaning. The open bottom 214 may cooperate with the openings 216 at the lower portion to facilitate self-cleaning. Self-cleaning reduces residual injection product from within the distribution tube 202 and avoids further contamination of a main product.

As described above, the distribution tube 202 is located in the static mixer 200 prior to the mixing elements 206 relative to a flow direction through the static mixer 200. Generally, the distribution tube 202 may be positioned anywhere in the range from the inlet 210 to a leading edge of a first mixing element 206. As shown in FIG. 3, the position of the distribution tube 202 may be defined by a distance D, which is a distance between an outer surface of distribution tube 202 and a center point (e.g. intersection) of a first set or pair of the mixing elements 206. According to one implementation, the distance D is approximately 55 mm when a length of the static mixer 202 is approximately 331 mm and the diameter of the static mixer is 85 mm. It is to be appreciated that this distance D may be the same for different sizes of static mixer 202; may scale for different sizes of static mixer 202; or may be subject to some other function or optimization based on one or more dimensions of the static mixer 202, a number of mixing elements 206, a desired flow performance, or the environment or application for which static mixer 202 is employed.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

1. A system, comprising:
a primary reservoir configured to store a first fluid;
a secondary reservoir configured to store a second fluid;
a primary pump configured to supply a first flow of the first fluid from the primary reservoir;
a secondary pump configured to supply a second flow of the second fluid from the secondary reservoir; and
a static mixer configured to receive the first flow at a primary inlet, to receive the second flow at an injection port, and to output a mixed fluid at an outlet,
wherein the static mixer includes a distribution tube coupled to the injection port, the distribution tube being configured to pre-mix the first fluid and the second fluid prior to mixing by one or more mixing elements of the static mixer.

2. The system of claim 1, wherein the distribution tube extends substantially across an inner diameter of the static mixer.

3. The system of claim 2, wherein an end of the distribution tube opposed from the injection port is open.

4. The system of claim 3, wherein the open end of the distribution tube facilitates self-cleaning of the distribution tube of residual second fluid.

5. The system of claim 1, wherein the distribution tube includes one or more openings to disperse the second fluid into the static mixer.

6. The system of claim 5, wherein the one or more openings include a plurality of openings grouped into pairs.

7. The system of claim 6, wherein each pair includes respective openings diametrically opposed to each other.

8. The system of claim 6, further comprising a first pair is positioned adjacent to the injection port and a second pair is positioned adjacent to an end longitudinally opposed from the injection port.

9. The system of claim 1, wherein the static mixer includes four mixing elements.

10. A static mixer, comprising:
a mixing chamber having one or more mixing elements;
an inlet at a first end of mixing chamber and configured to receive a first fluid;
an outlet positioned at a second end of mixing chamber, opposed from the first end, and configured to output a mixed fluid; and
a distribution tube inserted into the mixing chamber and configured to pre-mix the first fluid with a second fluid prior to further mixing by the one or more mixing elements.

11. The static mixer of claim 10, wherein the distribution tube includes an injection port configured to receive the second fluid.

12. The static mixer of claim 10, wherein the distribution tube extends substantially across an inner dimension of the mixing chamber.

13. The static mixer of claim 10, wherein the distribution tube includes a plurality of openings positioned along a length of the distribution tube.

14. The static mixer of claim 13, wherein the plurality of openings disperse the second fluid into the mixing chamber.

15. The static mixer of claim 13, wherein the plurality of openings include a first set of openings positioned near a first end of distribution tube within the mixing chamber.

16. The static mixer of claim 15, wherein the plurality of openings include a second set of openings positioned near a second end of the distribution tube within the mixing chamber.

17. The static mixer of claim 16, wherein the second set of openings have a smaller dimension than the first set of openings.

18. The static mixer of claim 16, wherein the second end of the distribution tube is open to the mixing chamber.

19. The static mixer of claim 18, wherein the second end is longitudinally opposed to the injection port.

20. The static mixer of claim 18, wherein the second end of the distribution tube facilitate self-cleaning of the distribution tube.
